(19) United States
(12) Patent Application Publication
(10) Pub. No.: US 2012/0145676 A1
(43) Pub. Date: Jun. 14, 2012

(54) Metal Ablation in Supersonic Expansion Gas Coupled to an Ion Mass Filter

(75) Inventor: Guido Fridolin Verbeck, IV, Plano, TX (US)

(73) Assignee: UNIVERSITY OF NORTH TEXAS, Denton, TX (US)

(21) Appl. No.: 13/309,250

(22) Filed: Dec. 1, 2011

Related U.S. Application Data
(60) Provisional application No. 61/418,680, filed on Dec. 1, 2010.

(51) Int. Cl. B23H 1/00

(52) U.S. Cl. 219/69.1

(57) ABSTRACT

A novel combined rectilinear ion trap mass spectrometer (RIT-MS)-coupled to expansion nozzle instrument and its application to preparative materials to create novel materials and material surfaces is described herein.

### CROSS-REFERENCE TO RELATED APPLICATIONS

This application claims priority to U.S. Provisional Application Ser. No. 61/418,680, filed Dec. 1, 2010, the entire contents of which are incorporated herein by reference.

### STATEMENT OF FEDERALLY FUNDED RESEARCH

This invention was made with U.S. Government support under Contract No. G72755 awarded by the Air Force Office of Scientific Research (AFOSR). The government has certain rights in this invention.

### TECHNICAL FIELD OF THE INVENTION

The present invention relates in general to the field of mass spectrometry (MS), and more particularly to a technique for forming clusters of metals by laser ablation and studying them by soft-landing.

### INCORPORATION-BY-REFERENCE OF MATERIALS FILED ON COMPACT DISC

None.

### REFERENCE TO A SEQUENCE LISTING

None.

### BACKGROUND OF THE INVENTION

Without limiting the scope of the invention, its background is described in connection with forming metal clusters by laser ablation.

U.S. Pat. No. 5,876,683 issued to Glumac et al. (1999) discloses a low pressure combustion flame method for the production of nanophase powders, coatings and free-standing forms. The process involves controlled thermal decomposition of one or more metalorganic precursors in a flat-flame combustor unit in which both temperature distribution and gas phase residence time are uniform over the entire surface of the burner. The combustion flame reactor of the Glumac invention is a versatile tool for: (1) high rate production of loosely agglomerated nanoparticle powders with controlled particle size and distribution, (2) uniform deposition of shape conformal nanophase coatings, and (3) net-shaped fabrication of nanocrystalline free-standing forms such as sheets, rings and drums.

U.S. Patent Application Publication No. 20090011953 (Cooks et al. 2009) provides methods and apparatuses that utilize mass spectrometry for preparation of a surface to have catalytic activity through molecular soft-landing of mass selected ions. Mass spectrometry is used to generate combinations of atoms in a particular geometrical arrangement, and ion soft-landing selects this molecular entity or combination of entities and gently deposits the entity or combination intact onto a surface.

### SUMMARY OF THE INVENTION

The present invention describes a novel combined Rectilinear Ion Trap Mass Spectrometer-coupled to expansion nozzle instrument and its application to preparative materials to create novel materials and material surfaces by utilizing the stoichiometric control of mass selection.

In one embodiment the instant invention discloses an apparatus for preparing one or more catalytic surfaces by laser ablation of one or more metals in presence of a reactant gas or gas mixture comprising: a mass spectrometer (MS), wherein the mass spectrometer is selected from the group consisting of rectilinear ion traps (RIT), time of flight (TOF), sectors, and quadrupole mass spectrometer, an expansion nozzle, wherein the MS is coupled to the expansion nozzle, wherein the one or reactant gas or gas mixture is introduced into the apparatus through the expansion nozzle, a source of laser or thermal energy for ablation of the one or more metals, and a landing surface for collection or for depositing the ions ejected from the apparatus. In specific aspects of the apparatus described hereinabove the MS is a rectilinear ion trap mass spectrometer and the expansion nozzle is a Gerry-Walker-Smalley nozzle.

In one aspect the reactant gas or gas mixture comprises a noble gas, wherein the reactant gas mixture comprises 1-10% Helium. In another aspect the reactant gas mixture comprises 5% Acetylene in Helium. In yet another aspect the one or more metals are pure metals or alloys and are deposited as one or more clusters on the landing surface. In yet another specific aspect the clusters comprise metal carbide clusters.

Another embodiment of the instant invention relates to a method of preparing one or more catalytic surfaces by laser ablation of one or more metals in presence of a reactant gas or gas mixture comprising the steps of: (i) providing an apparatus comprising: a) a mass spectrometer (MS), wherein the mass spectrometer is selected from the group consisting of rectilinear ion traps (RIT), time of flight (TOF), sectors, and quadrupole mass spectrometer, b) an expansion nozzle, wherein the MS is coupled to the expansion nozzle, wherein the one or reactant gas or gas mixture is introduced into the apparatus through the expansion nozzle, c) a source of laser or thermal energy for ablation of the one or more metals, and d) a landing surface for collection or for depositing the ions ejected from the apparatus; (ii) providing one or more metals, metal alloys or combinations thereof; (iii) exposing the metals the metal alloys or the combinations to the laser or the thermal energy to form one or more ions; (iv) selecting the metal ions to be deposited; (v) ejecting the selected metal ions; and (vi) collecting or depositing the metal ions on the landing surface.

One aspect of the method disclosed hereinabove further comprises the steps of characterizing one or more optical and electronic properties of the catalytic surface, wherein the step of characterizing the surface is performed by one or more techniques comprises Raman spectroscopy, atomic force microscopy, scanning electron microscopy (SEM) or combinations thereof. In another aspect the MS is a rectilinear ion trap mass spectrometer. In yet another aspect the expansion nozzle is a Gerry-Walker-Smalley nozzle.

In a related aspect the reactant gas or gas mixture comprises a noble gas, more specifically a 1-10% Helium or a mixture of 5% Acetylene in Helium. In another aspect the metals are deposited as one or more clusters on the landing surface. In another aspect the clusters comprise metal carbide clusters. In yet another aspect the instant invention discloses a catalytic surface made by the method discussed hereinabove.

### BRIEF DESCRIPTION OF THE DRAWINGS

For a more complete understanding of the features and advantages of the present invention, reference is now made to the detailed description of the invention along with the accompanying figures and in which:

FIG. 1 is a schematic showing the different components of an arrayed ion-trap assembly; and

FIG. 2 is a schematic of the instrument design of the rectilinear ion trap mass spectrometer coupled to expansion nozzle according to an embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The invention is used to create novel materials and material surfaces by utilizing the stoichiometric control of mass selection. The present inventors have designed a Rectilinear Ion Trap (RIT) Mass Spectrometer-coupled to expansion nozzle. The present invention is a novel instrument and application to preparative materials. The original nozzle was developed by Smalley, and improved by Gerry and Walker and the RIT was developed by Cooks. The application to preparative mass spectrometry is novel, as well as the combined instrumentation to ion trap mass spectrometry.

Soft landing as a form a preparative mass spectrometry is promising as a combing technique to allow for quick study and characterization of new materials. The soft-landing (SL) of ionized nanoclusters, metal-ligand complexes¹, polymers², and biopolymers³ intact on a hard surface is not a trivial task, but not novel either, in the sense that it was developed over a quarter century ago.⁴ Soft-Landing is used for the isolation, purification, and characterization of ionized compounds (proteins, catalyst, clusters, etc.), and research in this area has become more active within the last decade.⁵⁻⁷ Soft-landing instruments typically utilize mass spectrometers to isolate and land compounds with Quadrupoles^{7, 8}, Rectilinear Ion Traps⁶, Sectors⁹, and Ion Cyclotron Resonance^{10, 11}.

The present invention utilize soft landing to study optoelectronic properties of newly formed metal carbide clusters formed in situ. These clusters were formed via laser ablation in the presence of a reactant gas (5% acetylene in He gas) to form the desired clusters through the Gerry-Walker Smalley nozzle. The introductory gases used herein are usually mixed between 1% and 10% in Helium, or other noble gas and the metals can be pure or an alloy. Study of the new compounds is critical and advances the areas of dielectric materials as well as provides a base for new solid phase MEMS tribology.

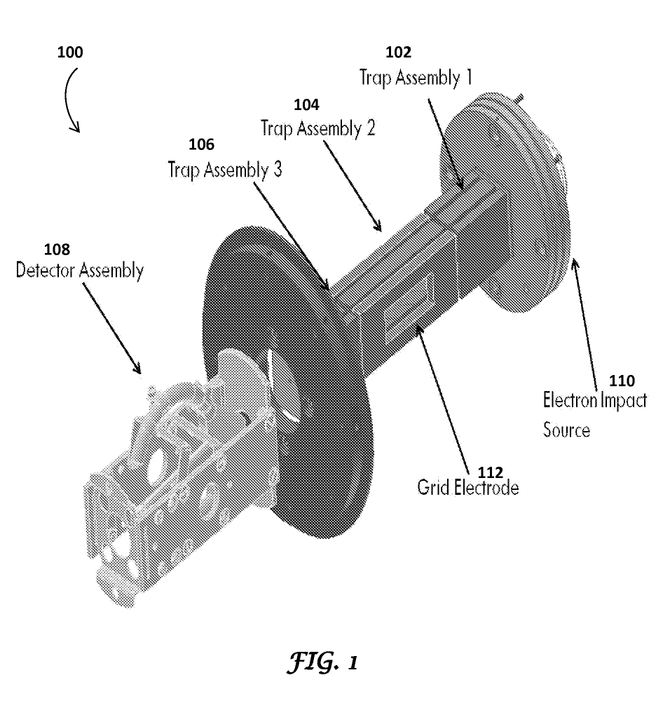

FIG. 1 is a schematic showing the different components of an arrayed ion-trap assembly 100, comprising three trap assemblies designated as Trap Assembly 1 (102), Trap Assembly 2 (104) and Trap Assembly 3 (106). The arrayed trap assembly also comprises a detector 108, an electron impact source 110 and a grid electrode 112.

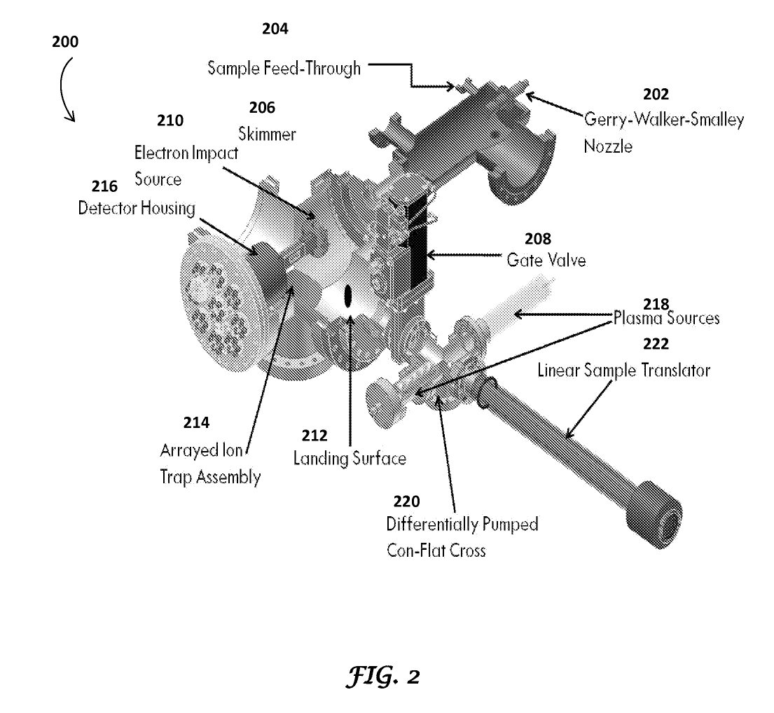

FIG. 2 is a schematic of the instrument design 200 of the rectilinear ion trap mass spectrometer coupled to expansion nozzle 202 according to an embodiment of the present invention. Metal carbide clusters are generated in situ via laser ablation of a metal rod in the presence of a super-sonic jet expansion of 5% acetylene in He gas through a Gerry-Walker-Smalley nozzle 202. After passing through a skimmer 206, the ions enter the main chamber containing the mass spectrometer. Mass selection of the ion clusters to be landed is completed with the rectilinear ion trap 214. The mass selection can also be performed by the range of mass spectrometers, ion trap, TOF, sectors, quadrupoles. Ions enter the trap axially from the cluster chamber and are ejected orthogonally toward a landing surface 212. Once the selected clusters have been successfully landed on the surface, further characterization techniques, including Raman spectroscopy, AFM, and SEM are employed to determine optical and electronic properties of the material.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Pat. No. 5,876,683: Combustion Flame Synthesis of Nanophase Materials.

U.S. Patent Application No. 20090011953: Methods and Apparatuses for Preparing A Surface to Have Catalytic Activity.

1. S. Nagaoka, T. Matsumoto, K. Ikemoto, M. Mitsui and A. Nakajima, Journal of the American Chemical Society 129 (6), 1528-1529 (2007).

2. M. B. J. Wijesundara, E. Fuoco and L. Hanley, Langmuir 17 (19), 5721-5726 (2001).

3. X. Yang, P. S. Mayer, F. Ture, ccaron and ek, Journal of Mass Spectrometry 41 (2), 256-262 (2006).

4. V. Franchetti, B. H. Solka, W. E. Baitinger, J. W. Amy and R. G. Cooks, International Journal or Mass Spectrometry and Ion Physics 23 (1), 29-35 (1977).

5. L. Hanley and S. B. Sinnott, Surface Science 500 (1-3), 500-522 (2002).

6. W.-P. Peng, M. P. Goodwin, Z. Nie, M. VolnyÌ, Z. Ouyang and R. G. Cooks, Analytical Chemistry 80 (17), 6640-6649 (2008).

7. O. Hadjar, P. Wang, J. H. Futrell, Y. Dessiaterik, Z. Zhu, J. P. Cowin, M. J. Iedema and J. Laskin, Analytical Chemistry 79 (17), 6566-6574 (2007).

8. B. Gologan, J. R. Green, J. Alvarez, J. Laskin and R. G. Cooks, Physical Chemistry Chemical Physics 7 (7), 1490-1500 (2005).

9. P. S. Mayer, F. TurecÌ(Eek, H.-N. Lee, A. A. Scheidemann, T. N. Olney, F. Schumacher, P. Strop, M. SmrcÌ(Eina, M. Patek and D. Schirlin, Analytical Chemistry 77 (14), 4378-4384 (2005).

10. J. Alvarez, R. G. Cooks, S. E. Barlow, D. J. Gaspar, J. H. Futrell and J. Laskin, Analytical Chemistry 77 (11), 3452-3460 (2005).

What is claimed is:

1. An apparatus for preparing one or more catalytic surfaces by laser ablation of one or more metals in presence of a reactant gases or gas mixture comprising:
a mass spectrometer (MS), wherein the mass spectrometer is selected from the group consisting of rectilinear ion traps (RIT), time of flight (TOF), sectors, and quadrupole mass spectrometer;
an expansion nozzle, wherein the MS is coupled to the expansion nozzle, wherein the one or reactant gases or gas mixture is introduced into the apparatus through the expansion nozzle;
a source of laser or thermal energy for ablation of the one or more metals; and
a landing surface for collection or for the deposition of one or more ions ejected from the apparatus.

2. The apparatus of claim 1, wherein the MS is a rectilinear ion trap mass spectrometer (RIT-MS).

3. The apparatus of claim 1, wherein the expansion nozzle is a Gerry-Walker-Smalley nozzle.

4. The apparatus of claim 1, wherein the reactant gases or gas mixture comprises a noble gas.

5. The apparatus of claim 1, wherein the reactant gas mixture comprises 1-10% Helium.

6. The apparatus of claim 1, wherein the reactant gas mixture comprises 5% Acetylene in Helium.

7. The apparatus of claim 1, wherein the one or more metals are pure metals or alloys.

8. The apparatus of claim 1, wherein the metals are deposited as one or more clusters on the landing surface.

9. The apparatus of claim 8, wherein the clusters comprise metal carbide clusters.

10. A method of preparing one or more catalytic surfaces by laser ablation of one or more metals in presence of a reactant gas or gas mixture comprising the steps of:
providing an apparatus comprising:
a mass spectrometer (MS), wherein the mass spectrometer is selected from the group consisting of rectilinear ion traps (RIT), time of flight (TOF), sectors, and quadrupole mass spectrometer;
an expansion nozzle, wherein the MS is coupled to the expansion nozzle, wherein the reactant gas or gas mixture is introduced into the apparatus through the expansion nozzle;
a source of laser or thermal energy for ablation of the one or more metals; and
a landing surface for collection or for depositing one or more ions ejected from the apparatus;
providing one or more metals, metal alloys or combinations thereof;
exposing the metals the metal alloys or the combinations to the laser or the thermal energy to form the one or more ions;
selecting the metal ions to be deposited;
ejecting the selected metal ions; and
collecting or depositing the metal ions on the landing surface.

11. The method of claim 10, wherein the method further comprises the steps of characterizing one or more optical, electronic properties or both of the catalytic surface.

12. The method of claim 11, wherein the step of characterizing the surface is performed by one or more techniques comprises Raman spectroscopy, atomic force microscopy (AFM), scanning electron microscopy (SEM) or combinations thereof.

13. The method of claim 10, wherein the MS is a rectilinear ion trap mass spectrometer (RIT-MS).

14. The method of claim 10, wherein the expansion nozzle is a Gerry-Walker-Smalley nozzle.

15. The method of claim 10, wherein the reactant gas or gas mixture comprises a noble gas.

16. The method of claim 10, wherein the reactant gas mixture comprises 1-10% Helium.

17. The method of claim 10, wherein the reactant gas mixture comprises 5% Acetylene in Helium.

18. The method of claim 10, wherein the metals are deposited as one or more clusters on the landing surface.

19. The method of claim 10, wherein the clusters comprise metal carbide clusters.

20. A catalytic surface made by the method of claim 10.
